(19) United States
(12) Patent Application Publication
(10) Pub. No.: US 2022/0374006 A1
(43) Pub. Date: Nov. 24, 2022

(54) METHOD OF PREDICTING AIRCRAFT ENGINE RELIABILITY BY PROACTIVELY DETECTING FAULTS

(71) Applicant: PARTH SINGH BATI, LIBERTY TOWNSHIP, OH (US)

(72) Inventor: PARTH SINGH BATI, LIBERTY TOWNSHIP, OH (US)

(21) Appl. No.: 17/322,934

(22) Filed: May 18, 2021

(51) Int. Cl. G05B 23/02; G07C 5/00; G07C 5/08

(52) U.S. Cl. CPC G05B 23/0283; G07C 5/008; G07C 5/006; G07C 5/0808

(57) ABSTRACT

A system predicting reliability for an engine of an aircraft includes an electronic engine controller, command input mechanisms in a cockpit of the aircraft, manual or automatic, a plurality of line replaceable units controlling functions for the aircraft engine and a computing and reporting system remote from the aircraft. The command input mechanisms transmit electronic command signals to the electronic engine controller, the electronic engine controller signals appropriate ones of the line replaceable units to carry out the commands, the line replaceable units perform the commanded functions and feed back to the electronic engine controller a record of functions actually performed and timing of the performance, and wherein at the end of each flight the records of actual performance are communicated to a data repository remote from the aircraft, associated with a specific aircraft and a specific engine.

### BACKGROUND OF THE INVENTION

### 1. Field of the Invention

the present invention is in the field of aircraft engines and it describes a method that can proactively collect and compute engine and line replaceable unit data to detect engine faults and predict reliability. Still, more particularly the presented invention relates to a method of using a web-based notebook to collect and compute engine flight data from last flight and other previous flights over time. The web-based notebook, then computes flight data by comparing it with expected ideal model data to early identify any potential faults before actual faults and predict reliability.

### 2. Discussion of the State of the Art

modern aircraft engines are controlled and operated by a fly-by-wire electronic engine control system. It is a system that replaced conventional manual flight controls of an aircraft with computer based electronic interfaces and engine control system. To meet aircraft demand, the engine changes position of line replaceable units. The line replaceable units follow commands from engine control systems and provide feedback based on their change in position. There is always some allowable lag and hence allowable error between the command going out of engine control system to line replaceable unit and feedback coming back from line replaceable unit to the engine control system. If there is a device malfunction in a line replaceable unit, then the error between command and feedback may exceed the expected lag and error limits. Engine control system may perceive this as a device fault and record an error.

Currently, there is no existing system that can proactively identify a potential failure. The current system reacts to a failure. Unexpected line replaceable unit failures can be unsafe to engine and aircraft operation. Aircraft operators rely on the original equipment manufacturer's recommendations about maintenance schedules and keep spare line replaceable units. However, there is no early warning of a potential line replaceable unit failure before it fails. For the safety of flight, engines are expected to operate event-free. Considering the safety of flight, a reactive strategy to deal with the failures in the growing and aging fleet is not acceptable.

Therefore, what is clearly needed is a method that can proactively monitor and compute the engine, line replaceable unit and flight data and its trends using a web-based notebook. This web-based notebook, then compares the collected data with expected data models. This method can flag the leading indicators that are trending too high or too low before that engine control system will not detect otherwise. Hence, by proactively predicting engine faults the method may help in predicting overall engine reliability.

### SUMMARY OF THE INVENTION

A method is presented that collects engine data through line replaceable units and proactively computes the data to identify fault trends and correlations, shifts in failure rates and intermittent faults. This is to early detect a trending potential failure before an actual failure. The present invention is a system of discovering engine failures before unseen problems can cause a delay, cancelation, or an in-flight fault. Any sort of in-flight or on-ground event puts everyone on board in a vulnerable situation. It is a safety risk for the aircraft engine operation and is not safe for the passengers travelling. Delays and cancellations in flights impact the schedules of passengers. Furthermore, unscheduled delays and cancellations are revenue impacts to the operators and engine manufactures.

In an event of a malfunction within engine or a line replaceable unit, the modern engines with electronic control system will be able to flag a fault. This fault will narrow down troubleshooting activities for the ground maintenance to quickly detect and correct the fault. However, the current electronic control system cannot predict when a line replaceable unit will fail. Hence the engine fault detection and reliability prediction are a reactive system.

Modern engines with electronic control system are capable of transferring flight data over to web-based notebook on the ground. At the end of each flight the flight data are sent from the engine to ground support either using wireless communication or hardwired transfer. This data transfer occurs between electronic control systems and web-based notebook on the ground. This data transfer can occur using wireless or hardwired connections. This flight data is stored on the ground information network.

The presented invention describes a web-based notebook that can be connected to the ground information network and may compute the recorded engine data. The invention interacts with the information network in the background without impacting its primary function of receiving and storing engine data. The web-based notebook that is part of this innovation has a memory module which is described in detail in the later section of this innovation. Web-based notebook has stored ideal mathematical models on its memory module. These ideal models represent expected engine and line replaceable unit behavior. The models are set to more stringent limits than that of an engine control system. The received engine data gets compared with the values of the model. In a normal operation the invention may indicate the health of the line replaceable unit. However, if the trend of engine data is suggesting of leaning towards a failure, then an alarm may be generated to notify the ground operation. This alarm will be used by the ground support to proactively address the potential fault situation before the aircraft is dispatched.

### BRIEF DESCRIPTION OF THE DRAWINGS

The features and believed characteristics of the innovation are set forth in the appended claims. The innovation may best be understood by reference to the following detailed description of the present disclosure when read in conjunction with the accompanying drawings, wherein:

FIG. 1 is a diagram of an aircraft with two engines in which an electronic engine control system may be installed. Each engine has its own control system. It shows an aircraft with two engines, however the present innovation may also be applicable to any other aircraft and engine configurations.

FIG. 2 is a diagram of an example of closed control loop. It shows closed loop control loop interaction between an aircraft, engine control system and line replaceable unit.

FIG. 3 is a diagram of an overall data processing system. It shows the communication between line replaceable unit, electronic engine control system and web-based notebook.

### DETAILED DESCRIPTION

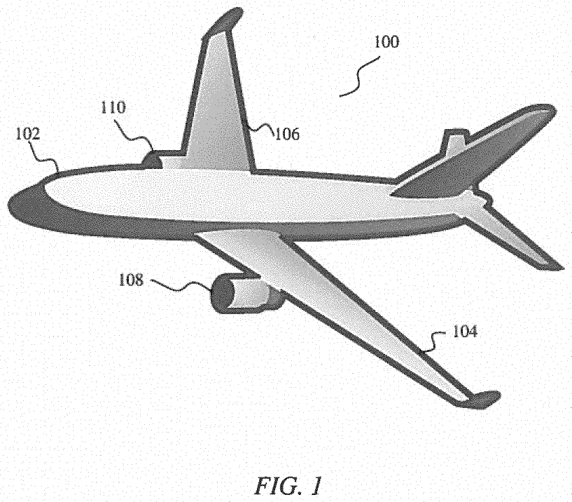

With reference to FIG. 1, a diagram of an aircraft is shown. The body of the aircraft is represented by 102 on which both wings are installed on. In this example, two engines 108 and 110 are shows mounted on aircraft wings 104 and 106 respectively. Engines shown can have their own independent electronic engine control systems and line replaceable units.

Although a wing mounted twin engine aircraft is illustrated in FIG. 1, this illustration is provided for purposes of illustrating one type of aircraft to get an overview of engine locations on an aircraft. The proposed method may be implemented in other types of aircraft with other numbers of engines and/or configurations of engines.

Engines 108 and 110 and their independent electronic engine control systems may be able to send data from their respective line replaceable unit and engine control systems to the web-based notebook.

In general, a commercial aircraft is expected to safely transfer passengers or cargo from one place to another by executing various flight phases to overall meet expected flight profile. The generic terminology of a flight phase may further be divided into few separate phases like, engine start, ground idle, taxi out, take off, initial climb, climb to cruise, cruise, descent, approach, landing, taxi in, ground idle and shutdown. Pilot is responsible to carry out a flight operation to meet the expected flight profile. Most of the flight phases of an aircraft are delivered by manual commands from the pilot. However, there may be also an option to perform flight phase in auto-pilot mode. In modern aircrafts, the demand from the pilot in manual or auto-pilot means is electronically communicated to the electronic engine control system. Engine control system acknowledges the flight phase requirements and follows the command by computing the demand signals into internal demand for engine internal changes to meet the aircraft demand.

Due to the fly-by-wire design, the modern aircraft engines are capable of automatically delivering a seamless flight operating according to pilot command or in autopilot operation during various flight operations. For an example, aircraft has a different set of expectations from an engine in a taxi phase as compared to take off phase or cruise phase. During the take-off phase, engine needs to quickly produce the thrust needed to lift off the aircraft and continue to do so during the climb phase. After the climb is achieved, cruise phase is focused on stabilizing and sustaining the engines and airplane at a constant lower thrust then that of takeoff phase. Engines are required to perform this during changing ambient conditions while producing and maintaining a constant high thrust. Based on changing ambient conditions, engine control system constantly sends updated demands to line replaceable units and they help the engine to maneuver between the phases of flight while ambient conditions and engine internal conditions are stabilizing as they progress towards cruise phase.

Engine control system follows a pilot demand by internally commanding and monitoring change in line replaceable unit position. Engine control system demand changes line replaceable unit position and that in turn puts engine in a condition that satisfies overall pilot demand. A line replaceable unit is a modular component of an engine that is replaceable on the wing, in the field or at an operating station that is otherwise remote from a manufacturing facility, a maintenance depot, or other maintenance location. This flexibility in line replaceable unit installation/removal allows operators to quickly address any issues at the flight line. Line replaceable units can improve maintenance operations by providing flexibility, because they can be stocked and replaced quickly with nearby on-site inventories, restoring the mobile systems to service, while the failed line replaceable unit is undergoing through a repair and/or overhaul at other support locations.

Some types of line replaceable units provide fuel flow to combustor based on pilot command. The opening and closing of these line replaceable units, based on demand regulate the fuel flow. If there is an error in the command and feedback, then that may result in wrong fuel flow.

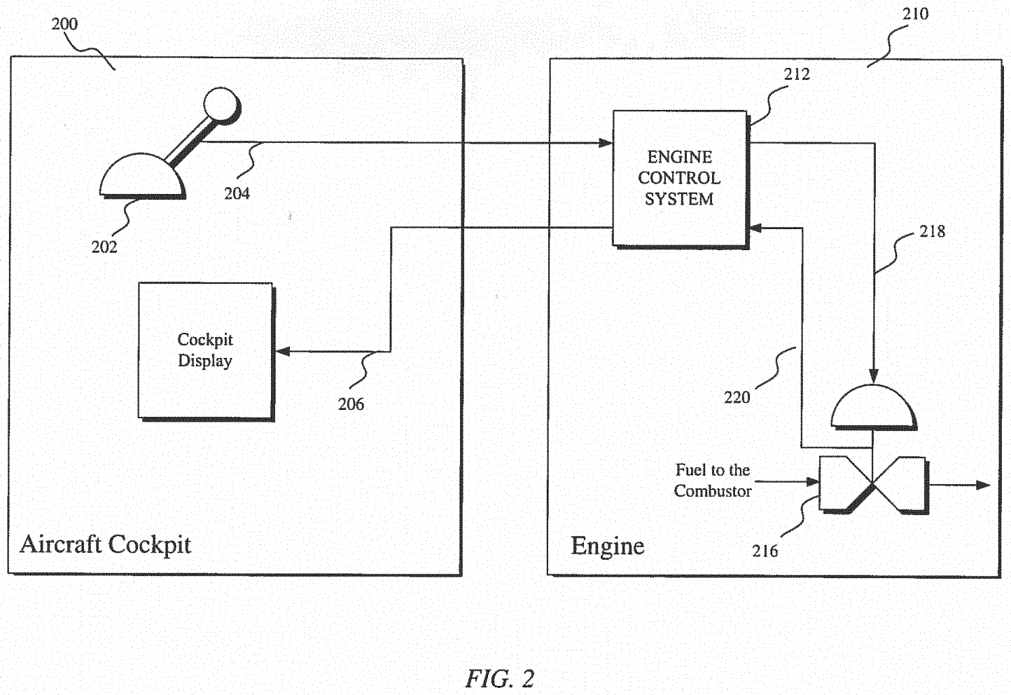

With reference to FIG. 2, a diagram of a closed loop control between aircraft, engine control system and line replaceable unit. FIG. 2 provides a general idea of a correlation between airplane demand and in turn engine's response to meet that demand. Aircraft is shown as 200 and engine is shown as 210. On aircraft side, 202 represents throttle or thrust lever which is generally located in the cockpit. On the engine side, 212 represents an electronic engine control system. 216 represents the fuel valve.

Pilot can demand higher engine thrust by pushing the thrust lever 202 forward and lower engine thrust by pulling it back. In this example of FIG. 2, a flight phase is represented where the pilot is pushing the throttle forward to demand more thrust. An electronic signal 204 is sent from throttle to the engine control system. This signal 204 represents the physical throttle movement in electronic form. Once the engine control system receives signal 204, it will process this input signal and internally calculates the fuel valve 216 open position that is needed to achieve the increase in pilot thrust demand. The engine control system then sends a signal 218 to the fuel valve to open accordingly. This signal will command the fuel valve to open. Opening the valve will allow more quantity of fuel to pass through the valve and into the engine combustor. More fuel going into the combustor will make the engine run at higher thrust. As the valve is changing its position from close to more open or fully open, a feedback signal 220 is sent back from the line replaceable unit to the engine control system. This feedback signal 220 is an acknowledgement, confirmation to the engine control system that the line replaceable unit is carrying out the position change to meet aircraft demand. Based on this line replaceable unit feedback signal 220, engine control system calculates engine thrust based on how much the valve is open compared to demand and other ambient conditions like fuel temperature and pressure. Engine control system then sends a feedback signal 206 back to the aircraft. Signal 206 is a conformation for the aircraft and pilot that the demanded thrust is achieved.

On FIG. 2, both signals command to the line replaceable unit 218 and feedback from the line replaceable unit 220 are connected to the engine control system. Hence every output signal value from engine control system has a correlated expected feedback signal value. This correlated expected value keeps in account expected lag in the system as explained earlier in this description. In the example of FIG. 2, if engine control system commands line replaceable unit to fully open then in return engine control system expects to receive a feedback signal that relates to fully open position of the line replaceable unit and the lag in the system. If there is a malfunction in a line replaceable unit, then the error between command and feedback may exceed the expected lag & error limits. In this malfunction situation, the engine control system is sending the demand to fully open the line replaceable unit and the line replaceable unit is sending the feedback of anything other than fully open. Engine control system may perceive this as a device fault and record an error. There may be one or more reasons behind device malfunction. Damaged part, wire chafing, fuel leakage, fuel coking, fuel contamination, feedback device malfunction is to name a few.

FIG. 2 represents an example of one type of line replaceable unit and its closed loop control loop with engine control system and the aircraft. Some other types of line replaceable units are critical to keep the engine temperature in control specially for the turbine parts who handle extremely high temperatures. These line replaceable units bring cool air onto the hot sections of the engine. This cooling flow is critical to keep critical components away from extreme temperature exposure. Extreme temperatures contribute to cracking of the surface of some of the critical engine parts.

The closed loop control system described in FIG. 2 is reactive and not proactive. In case of a fault situation the system reacts and is prepared to safeguard the engine. However, the system is not capable of proactively anticipating faulty conditions in a hardware like line replaceable unit and control system or in communication malfunction between the two. Aircraft operators and shops perform preventive maintenance, which is helpful up to a certain level in early identifying potential faults. However, the current system is not capable of accessing internal health of individual line replaceable unit, feedback devices and communication links. Hence, time and time again we see delays, cancellations, and in-flight engine malfunctions. These currently unpredicted fault conditions can occur due to unexpected damage of line replaceable unit, wire chafing, fuel leakage, fuel coking, fuel contamination, feedback device malfunction is to name a few. The innovation described here may help in overcoming this limitation of the current system.

The proposed innovation describes a method and systems that may proactively detect engine faults before an actual fault can occur and hence predict the reliability of an engine. The method describes a system of a web-based notebook that may collect flight data from the engine control system. The method describes a system which is an internal part of the web-based notebook. The system has mathematical models of line replaceable unit expected behavior with expected error limits and time durations when exceeded a fault will set. The mathematical model internal to the web-based notebook has limits more stringent that of the engine control system. Web-based notebook compares actual line replaceable unit data with expected data. This comparison will be done both instantaneously and over time. The data collected over time will show a trend upwards or downwards drifting away from the expected model data. This is because aging line replaceable unit, chafing wires, fuel leaks, fuel contaminations, etc. So, the trend comparison will early identify a potential fault condition before the line replaceable unit and the engine encounters an actual fault condition. Referring to FIG. 4, if the fuel valve hardware is expecting a wear then it will require control systems to put a larger quantity of milliampere electrical current signal to obtain same valve position that was achieved on a brand new valve with no hardware wear. The comparison with the expected model will highlight this delta between the expected milliampere and the higher trending actual milliampere. Web-based notebook will flag this increased milliampere value and report it out to the ground engine maintenance personnel.

Like the engine control system, the innovation and the method described in the web-based notebook will have a set limit on the allowable difference between the expected model value and actual value. The difference between the two is that the limits on, the engine control system is more stringent than that of electronic engine control system. In general, web-based notebook will have five percent more restricting limit than that of the engine control system. All the potential faults there are close within five percent limit are trending towards failure but does not resulted into actual failure yet will get identified by the innovation and the method described here. The engine control system would have not caught these faults and allowed dispatch of the aircraft. The web-based notebook will catch them and flag a potential failure.

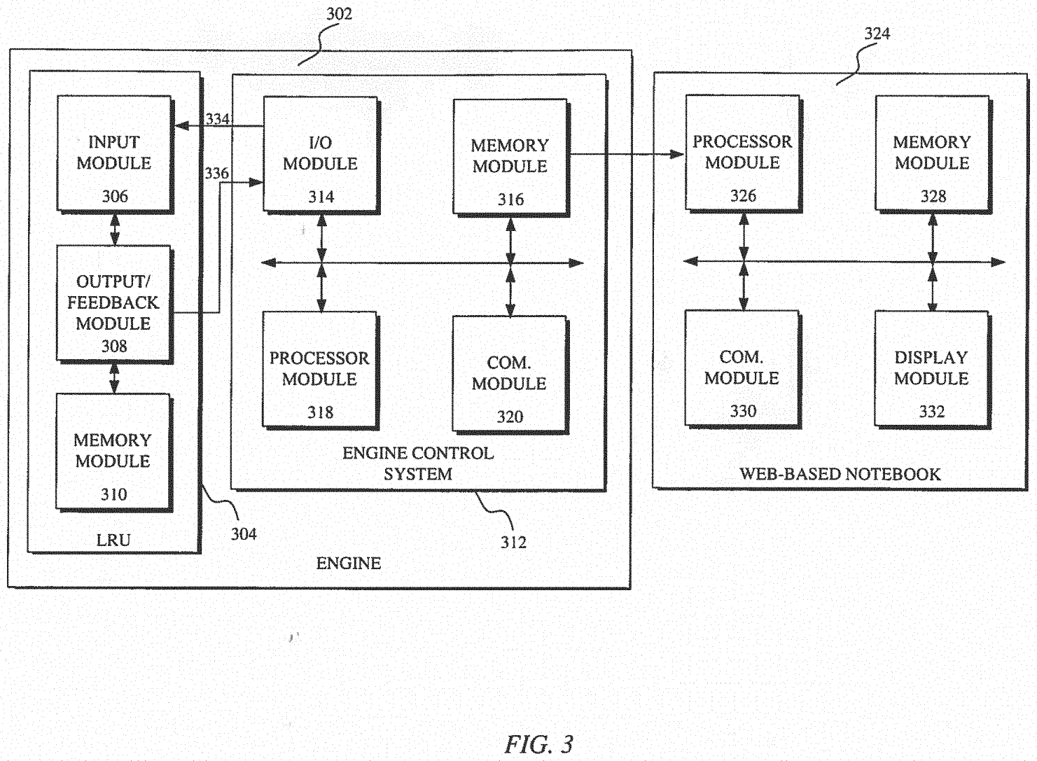

Referring to FIG. 3, the described innovation and the method will continuously receive flight data of each engine either wireless or via a wired communication link. The received data will be of same engines multiple flights, same aircrafts multiple flight overtime. This way the innovation and the method will have a vast amount of data points available to create trends and identify potential failures. The innovation and the method can also be useful if it catches the trend of a similar type in one engine to predict the same trend in other similar types of engines.

FIG. 3 shows a detailed diagram of a data processing system from engine to on ground web-based notebook. This diagram shows the modular communication between line replaceable unit, engine control system and web-based notebook. Aircraft 100 and in particular, the engines 108 & 110 shown in FIG. 1 can be represented by the data processing system.

Within line replaceable unit 304, there may be three different modules functioning according to engine demand. Input module, 306 receives command signal 334 from engine control system input/output module 314. Output or feedback module 308 within the line replaceable unit provides feedback signal 336 to the engine control system. Line replaceable unit is also capable of storing its position change information throughout the flight within the memory module 310. This retained data can be extracted from memory module 301 later through the web-based notebook 324.

Within engine control system 312, there may be four different modules functioning to meet engine and airplane demands. Processor module 318 serves to execute instructions for software that may be loaded into memory 316. Processor module 318 may be a set of one or more processors or may be a multi-processor core, depending on the implementation. Further, processor module 318 may be implemented using one or more heterogeneous processor systems in which a main processor is present with secondary processors on a single chip. As another illustrative example, processor module 318 may be a symmetric multi-processor system containing multiple processors of the same type.

Memory module 316 is an example of storage devices. A storage device is any piece of hardware that can store information either on a temporary basis and/or a permanent basis. The memory module 316, in this example, may be, for example, a random-access memory or any other suitable volatile or non-volatile storage device. Memory module 316 may take various forms depending on the implementation.

For example, the memory module 316 may contain one or more components or devices. For example, it 308 may be a hard drive, a flash memory, or some combination of the above. The media used by storage 316 also may be removable. For example, a removable hard drive may be used for storage 316.

Communications module 320, in this example, provides for communications with other data processing systems or devices. In these examples, communications module

What is claimed is:

1. A system predicting reliability for an engine of an aircraft, comprising:
an electronic engine controller;
command input mechanisms in a cockpit of the aircraft, manual or automatic;
a plurality of line replaceable units controlling functions for the aircraft engine; and
a computing and reporting system remote from the aircraft;
wherein the command input mechanisms transmit electronic command signals to the electronic engine controller, the electronic engine controller signals appropriate ones of the line replaceable units to carry out the commands, the line replaceable units perform the commanded functions and feed back to the electronic engine controller a record of functions actually performed and timing of the performance, and wherein at the end of each flight the records of actual performance are communicated to a data repository remote from the aircraft, associated with a specific aircraft and a specific engine.

2. The system of claim 1 wherein the stored records of actual performance are provided to a computing and reporting system which compares the records of actual performance with pre-stored standards of ideal performance and determines and records deviations for the specific aircraft and specific engine.

3. The system of claim 1 wherein the computing and reporting system records trends over time for multiple instances of performance of functions and deviation from ideal and issues an alert for an engine when performance from ideal has deviated to a preset level.

4. The system of claim 1 wherein the line replaceable units that execute critical engine control commands.

5. The system of claim 1 wherein the command input mechanism is a command from aircraft or engine to line replaceable units.

6. The system of claim 1 wherein the command input mechanism can be manual or automatic.

7. The system of claim 1 wherein the feedback from line replaceable units to engine control system.

8. The system of claim 1 wherein the computing and reporting system can be a remote web-based system or a remote computer based system, and the records of actual performance data of multiple engines from multiple flights are uploaded to the computing and reporting system between flights of the aircraft.

9. A method predicting reliability for an engine of an aircraft, comprising:
transmitting electronic commands to an electronic engine controller by command input mechanisms in a cockpit of an aircraft;
signaling appropriate ones of a plurality of line replaceable units by the electronic engine controller to perform functions according to the electronic commands;
performing the commanded functions by the line replaceable units;
feeding back to the electronic engine controller records of functions actually performed and timing of the performances; and
transmitting the records of actual performance associated with a specific aircraft and a specific engine to a data repository remote from the aircraft at the end of each flight of the aircraft.

10. The method of claim 9 comprising providing the stored records of actual performance to a computing and reporting system which compares the records of actual performance with pre-stored standards of ideal performance and determines and records deviations for the specific aircraft and specific engine.

11. The method of claim 9 comprising recording, by the computing and reporting system, trends over time for multiple instances of performance of functions and deviation from ideal, and issuing an alert for an engine when performance from ideal has deviated to a preset level.

12. The method of claim 9 comprising controlling the line replaceable units.

13. The method of claim 9 comprising generating a command to line replaceable units by engine controller.

14. The method of claim 9 comprising generating a command to the engine controller that can be manual or automatic.

15. The method of claim 1 comprising uploading the records of actual performance to a web-based computing and reporting system between flights of the aircraft.
